(19) United States
(12) Patent Application Publication
(10) Pub. No.: US 2017/0167075 A1
(43) Pub. Date: Jun. 15, 2017

(54) ANTIVIRAL FINISHED PRODUCT PRODUCTION METHOD, AND ANTIVIRAL FINISHED PRODUCT PRODUCED BY THE METHOD

(71) Applicant: OSAKA KASEI CO., LTD., Osaka-shi, Osaka (JP)

(72) Inventors: Kimio Suzuki, Osaka-shi (JP); Tomohide Kanda, Osaka-shi (JP)

(73) Assignee: OSAKA KASEI CO., LTD., Osaka-shi, Osaka (JP)

(21) Appl. No.: 15/325,803

(22) PCT Filed: Jul. 9, 2015
(86) PCT No.: PCT/JP2015/069711

§ 371 Date: Jan. 12, 2017

(30) Foreign Application Priority Data
Jul. 18, 2014 (JP) 2014-147749

(51) Int. Cl. D06M 13/46; A01N 33/12; C08J 7/06

(52) U.S. Cl. CPC D06M 13/46; C08J 7/065; A01N 33/12; C08J 2367/00; D06M 2101/32

(57) ABSTRACT

According to the present disclosure, a resin product is brought in contact with a treatment liquid containing an antiviral compound (A) of a quaternary ammonium halide having a molecular weight of not greater than 1500 and, in this state, heat-treated under a normal pressure or under an increased pressure, whereby the antiviral compound (A) is immobilized on at least a surface of the resin product. Thus, an excellent antiviral finished product having water resistance and laundry durability is provided.

### TECHNICAL FIELD

The present disclosure relates to a production method for an antiviral finished product having water resistance and laundry durability, and an antiviral finished product produced by the production method.

### BACKGROUND ART

Viruses such as human influenza viruses, avian influenza viruses (congeneric to the human influenza viruses), noroviruses, Ebola hemorrhagic viruses and AIDS viruses cause enormous life and economic losses of humans and livestock. Recently, death of elderly people and immunodeficient people resulting from complications caused by mass food poisoning due to the noroviruses in winter has been reported. Further, WHO (World Health Organization) has pointed out the pandemic threat of the avian influenza viruses.

In order to protect humans and the livestock from the threat of these viruses, various antiviral liquid sterilizers are conventionally used in living environments. It is conventionally known to use sodium hypochlorite, iodophor or a cationic surface active agent for envelope type viruses (e.g., human influenza viruses and avian influenza viruses). It has been recently reported that a liquid spray of a composite agent containing a polyalkylene biguanide hydrochloride (PHMB) and a quaternary ammonium salt compound is effective for non-envelope type viruses (e.g., noroviruses) (see PTL 1).

Further, various studies have been conducted on methods of maintaining an antiviral effect by applying the antiviral compounds directly to various household articles and industrial materials including clothes, rather than spraying or applying the antiviral compounds in the form of liquid sterilizers onto hand fingers and hard surfaces for sterilization. Exemplary methods hitherto reported include a method in which an epoxy or melamine coating formable compound is used in combination with any of the antiviral compounds to form a resin coating on fiber surfaces or in inter-fiber spaces to immobilize the antiviral compound on a fiber product (see PTL 2), and a method in which a fiber product is treated with an antibacterial component, a specific polycarboxylic acid and a crosslinking agent (see PTL 3).

### RELATED ART DOCUMENT

### Patent Document

PTL 1: JP-A-2013-14551

PTL 2: JP-A-2008-115506

PTL 3: JP-A-2003-105674

### SUMMARY OF INVENTION

However, the method in which the coating formable compound is used to form the resin coating to immobilize the antiviral compound on the fiber product has a problem such that the formation of the resin coating impairs the air permeability and the texture of the fiber product and, therefore, is not suitable for clothes and interior materials. As the resin coating is removed by friction or the like, the antiviral property is deteriorated, making it impossible to maintain the antiviral performance of the fiber product for a longer period of time. Further, the melamine compound and a glyoxal compound to be used for the formation of the coating are problematically liable to release formalin to adversely influence the environment and human bodies. The antiviral compounds to be used for these methods are required to be brought into intimate contact with fibers and, hence, have a relatively great molecular weight. Therefore, the type of the antiviral compound is limited.

In view of the foregoing, it is an object to provide a production method for an excellent antiviral finished product having a water-resistant and laundry-durable antiviral property, and an antiviral finished product produced by the production method.

According to a first inventive aspect to achieve the aforementioned object, there is provided an antiviral finished product production method for producing an antiviral finished product having an antiviral property, the method including the steps of: preparing a resin product; preparing a treatment liquid containing an antiviral compound (A) of a quaternary ammonium halide having a molecular weight of not greater than 1500; and immobilizing the antiviral compound on at least a surface of the resin product by heat-treating the resin product under a normal atmospheric pressure or under an increased pressure with the resin product in contact with the treatment liquid.

According to a second inventive aspect, the resin product comprises at least one resin selected from a polyester resin, a polyamide resin, an acryl resin and a polyurethane resin in the antiviral finished product production method.

According to a third inventive aspect, in the step of immobilizing the antiviral compound (A) on at least the surface of the resin product, having the resin product in contact with the treatment liquid is performed by spraying the treatment liquid onto the resin product, by immersing the resin product in the treatment liquid or by coating the resin product with the treatment liquid, and the heat-treating is performed in a gas at 70° C. to 230° C. under the normal atmospheric pressure or under the increased pressure. According to a fourth inventive aspect, in the step of immobilizing the antiviral compound (A) on at least the surface of the resin product, having the resin product in contact with the treatment liquid is performed by immersing the resin product in the treatment liquid, and the heat-treating is performed in the treatment liquid at 70° C. to 230° C. under the normal atmospheric pressure or under the increased pressure.

According to a fifth inventive aspect, there is provided an antiviral finished product produced by the production method according to any of the first to fourth inventive aspects, the antiviral finished product including a resin product and an antiviral compound (A) immobilized on at least a surface of the resin product, the antiviral compound (A) being a quaternary ammonium halide having a molecular weight of not greater than 1500, the antiviral finished product having an antiviral activity level of not less than 3.

According to a sixth inventive aspect, the resin product of the antiviral finished product comprises at least one resin selected from a polyester resin, a polyamide resin, an acryl resin and a polyurethane resin.

According to a seventh inventive aspect, the resin product of the antiviral finished product is a fiber product. According to an eighth inventive aspect, the resin product of the antiviral finished product is one of a resin sheet, a resin film and a cured resin product having a predetermined shape.

In the present disclosure, the term “resin product” means a material product from which the final product is produced, and the final product may have the same shape as the material product without modification in the shape of the material product.

In the present disclosure, the expression “to immobilize the antiviral compound (A)” means that the antiviral compound (A) is chemically bonded to the resin product. Examples of the chemical bonding include covalent bonding, ion bonding, hydrogen bonding and coordinate bonding.

The inventors conducted intensive studies to develop a method of imparting a resin product (e.g., any of various industrial materials and household articles including clothes) with a water-resistant and laundry-durable antiviral property. As a result, the inventors found that, where the antiviral compound (A) of the quaternary ammonium halide having a molecular weight not greater than the predetermined level is used out of quaternary ammonium salts conventionally known as antibacterial agents, the antiviral compound (A) can be directly bonded to functional groups of the resin of the resin product to be immobilized on the resin product by dissolving or dispersing the antiviral compound (A) in a solvent such as water for the preparation of the treatment liquid and heat-treating the resin product with the treatment liquid in contact with the resin product without forming the resin coating with the use of the coating formable compound. Further, the inventors found that the antiviral compound (A) immobilized on the resin product has excellent antiviral effects against the envelope type viruses (the human influenza viruses, the avian influenza viruses and the like) as well as the non-envelope type viruses (the noroviruses, the feline caliciviruses and the like) and makes it possible to impart various resin products with a water-resistant and laundry-durable antiviral property, and attained the present disclosure.

There are a lot of compounds known as the antibacterial agents. It is known that some of these compounds have an antiviral effect against specific viruses. However, the inventors teach for the first time that the antiviral compound (A) according to the present disclosure has an excellent antiviral effect against both the envelope type viruses and the non-envelope type viruses.

That is, bacteria to be targeted by antibacterial agents are microorganisms each having a metabolic system, and compounds inhibiting the metabolic system are advantageously used as the antibacterial agents. On the other hand, viruses to be targeted by antiviral agents are proteins each having no metabolic system unlike the bacteria. Therefore, the antiviral agents are required to act directly on the proteins to modify or decompose the proteins. Accordingly, the antibacterial agents cannot be employed as they are for the viruses. Therefore, the inventors studied various substances in detail and, as a result, found that the quaternary ammonium halide is capable of strongly adsorbing amino acids of the proteins of the viruses to modify the viruses irrespective of the type of the viruses.

In addition, the quaternary ammonium halide is a water-soluble compound. Therefore, it has been considered difficult to immobilize the quaternary ammonium halide on a hydrophobic resin surface on an as-is basis in a water-resistant and laundry-durable manner. It is common general knowledge to use the coating formable compound to confine the water-soluble compound in the resin coating to immobilize the water-soluble compound on resin surfaces of synthetic fibers and the like as previously described. In the field of dyeing technology, it is a known practice to modify hydrophobic polyester fibers by incorporation of sulfone groups and then dye the polyester fibers with water-soluble cationic dye. However, a method of immobilizing the water-soluble compound directly on the hydrophobic resin without modification is not known.

In contrast, the inventors conceived that, where the resin product to be incorporated with the quaternary ammonium halide (which is highly heat-resistant) is heated to not lower than a glass transition temperature of the resin of the resin product to allow the quaternary ammonium halide to infiltrate into voids present in amorphous resin portions, the halide can be chemically bonded to unreacted functional groups remaining in the resin. As a result of actual verification, the inventors found that a quaternary ammonium chloride having a relatively small molecular weight, e.g., having a molecular weight of not greater than 1500, can be incorporated into the amorphous resin portions and bonded to the functional groups of the resin by hydrogen bonding or the like to be immobilized on the resin product.

According to the inventive production method, the specific antiviral compound (A) having an antiviral effect against both the envelope type viruses and the non-envelope type viruses can be directly chemically bonded and immobilized on the resin product without the formation of the resin coating or the like. Thus, the antiviral finished product can be produced as having excellent water resistance and laundry durability. The production does not require a special apparatus, but an equipment (e.g., a dyeing equipment for fiber products) adapted to heat-treat the resin product in contact with the treatment liquid containing the antiviral compound (A) can be used on an as-is basis for the production, thereby reducing the production costs. Without the need for the coating formable compound (i.e., a binder resin) for the immobilization of the antiviral compound (A), an additional material cost is not required for the production.

The inventive antiviral finished product has an excellent antiviral property against both the envelope type viruses and the non-envelope type viruses, and the antiviral property can be effectively maintained for a longer period of time with water resistance and laundry durability. The antiviral finished product can be repeatedly washed with water, wiped with a wet cloth or subjected to laundry without loosing the antiviral property and, therefore, can be maintained clean for a longer period of time.

Where the resin product comprises at least one resin selected from the polyester resin, the polyamide resin, the acryl resin and the polyurethane resin in the inventive production method, the antiviral compound (A) can be more firmly and more stably immobilized on the resin product because these resins each have a greater number of unreacted functional groups. Therefore, this arrangement is advantageous.

Where the antiviral compound (A) is applied to the resin product by spraying the treatment liquid onto the resin product, by immersing the resin product in the treatment liquid or by coating the resin product with the treatment liquid, and then the resulting resin product is heat-treated in the gas at 70° C. to 230° C. under normal atmospheric pressure or under increased pressure in the step of immobilizing the antiviral compound (A) on at least the surface of the resin product in the inventive production method, or where the resin product is immersed in the treatment liquid and heat-treated in the treatment liquid at 70° C. to 230° C. under normal atmospheric pressure or under the increased pressure in the step of immobilizing the antiviral compound (A) on at least the surface of the resin product in the inventive production method, the antiviral finished product is imparted with excellent water resistance and laundry durability. Therefore, these arrangements are advantageous.

### DESCRIPTION OF EMBODIMENTS

Next, the present disclosure will be described by way of an embodiment thereof.

<Antiviral Finished Product>

First, a product to be treated to be imparted with an antiviral property according to the embodiment of the present disclosure may be a resin product. As previously described, the resin product to be prepared before the treatment may have the same shape as a final product, or may be deformed or combined with other component to provide a final product modified in shape and/or construction.

The product to be treated may be any of various industrial materials and household articles. Exemplary resins to be used for the resin product for the antiviral finished product include synthetic resins such as a polyester resin, a polyamide resin, an acryl resin and a polyurethane resin, and composite materials and mixtures of any of these synthetic resins. Other exemplary materials for the resin product include mixtures of any of the aforementioned synthetic resins and other materials (e.g., metals, inorganic substances and the like). Synthetic fibers of any of these synthetic resins are also usable for the product to be treated. The product to be treated also include fiber blend materials including any of the synthetic fibers and natural fibers such as of cotton, rayon, wool or silk.

Particularly, preferred examples of the resin to be used for the antiviral finished product with a higher demand and required to have laundry durability include polyester resins such as polyethylene terephthalates, polytrimethylene terephthalates, polybutylene terephthalates and polylactic resins, and mixtures of any of these polyester resins and another resin (in the case of a fiber product, fiber blend materials including fibers of any of these polyester resins and fibers of another resin). The present disclosure is applicable to antiviral finished products made of any of these materials.

Where the product to be treated is a fiber product in the embodiment of the present disclosure, examples of the fiber product include yarns, strings, ropes and fabrics (woven fabrics, knitted fabrics and nonwoven fabrics). Specific examples of the household articles include bedding materials (curtains, bed sheets, towels, bed fabrics, bed padding, mattresses, carpets, pillow covers and the like), garments (coats, suits, sweaters, blouses, shirts, underwear, caps, face masks, socks, gloves and the like), and uniforms (medical gowns, working clothes, school uniforms and the like). The product to be treated is not limited to the fiber products, but other examples thereof include household articles and industrial materials formed from resin materials such as resin sheets and resin films. Specific examples include nursing-care sheets, shower curtains, automotive seats, seat covers, interior materials such as ceiling materials, tents, insect/bird screens, partition sheets, air conditioner filters, vacuum cleaner filters, masks, tablecloths, desk mats, aprons, wall sheets and wrapping sheets. Other examples include medical articles (medical beds, wheelchairs, sterilization bags and the like), sanitary articles (toilet bowls, cleaning brushes, dust boxes, disposable gloves, disposable masks and the like), and cooking articles (serving tables, trays and the like). The present disclosure is applicable not only to sheet-shaped products and film-shaped products but also to cured resin products (resin products) having predetermined shapes. The present disclosure is applicable to these articles, which may be subjected to the antiviral treatment in the same manner.

<Antiviral Compound (A)>

An antiviral compound (A) to be used in the embodiment of the present disclosure is a quaternary ammonium halide having a molecular weight of not greater than 1500.

Examples of the quaternary ammonium halide include tetramethylammonium iodide, trimethyldecylammonium bromide, didecyldimethylammonium bromide (hereinafter abbreviated as “DDRB”), dodecyldimethyl-2-phenoxyethylammonium bromide, lauryltrimethylammonium bromide, cetyltrimethylammonium bromide, didecyldimethylammonium chloride (hereinafter abbreviated as “DDAC”), trimethylammonium chloride, trimethyldodecylammonium chloride, trimethyltetradecylammonium chloride, cetylpyridinium chloride, trimethylhexadecylammonium chloride, trimethyloctadecylammonium chloride, didecylmonomethylhydroxyethylammonium bromide, alkyldimethylhydroxyethylammonium chlorides, alkyltrimethylammonium bromides, dioctyldimethylammonium chloride, dioctyldimethylammonium bromide, octyldecyldimethylammonium chloride, octyldecyldimethylammonium bromide, methylbenzethonium chloride, alkyldimethylbenzylammonium chlorides (hereinafter abbreviated as “BAC”), al kylpyridiniumammonium chlorides and dialkylmethylbenzylammonium chlorides. Polymers, such as poly[oxyethylene(dimethylimino)ethylene(dimethylimino)ethylene dichloride], poly[oxyethylene(dimethyliminio)trimethylene(dimethyliminio)ethylene dichloride] and polydiallyldimethylammonium chloride, each having a molecular weight of not greater than 1500 are also usable.

Among these, the DDAB, the DDAC and the BAC are particularly preferred, and may be used alone or in combination.

<Treatment Liquid>

In a production method according to the embodiment of the present disclosure, a treatment liquid containing the antiviral compound (A) of the quaternary ammonium halide is prepared. The treatment liquid is an aqueous solution of the antiviral compound (A) generally prepared by dissolving the antiviral compound (A) in water. In some cases, the treatment liquid may be a solution of the antiviral compound (A) employing an organic solvent, or a dispersion of the antiviral compound (A). Various auxiliary agents and additives may be blended in the treatment liquid depending on the type of the resin product to be treated and conditions for the treatment.

<Auxiliary Agents and Additives Usable for Treatment Liquid>

Where a fiber blend product including the polyester fibers and the natural fibers such as of cotton, rayon, wool or silk or a fiber blend product including the polyester fibers and the polyamide, acryl or polyurethane fibers is treated, for example, fibers other than the polyester fibers are liable to be abnormally discolored, hardened or shrunk due to the action of the cation of the antiviral compound (A) or to lose the antiviral property depending on the treatment temperature and the treatment period to be employed for the treatment of the fiber blend product. In order to prevent abnormality, fiber treatment agents such as a fixer, a dye retardant and a fluorescent brightening agent are preferably used as the auxiliary agents. Similarly, where a resin product made of a resin blend material including a polyester resin and a polyamide, acryl or polyurethane resin is treated, the fiber treatment agents are preferably used.

Specific examples of the fiber treatment agents include: alkali salt compounds typified by anhydrous sodium carbonate; neutral salt compounds typified by sodium sulfate (Glauber's salt); nonionic surface active agents such as of an alkyl ether type, a polycyclic phenyl ether type, a sorbitan derivative type and an aliphatic polyether type; cationic surface active agents typified by quaternary ammonium salts (excluding the quaternary ammonium halides to be used as the antiviral compound (A)); anionic surface active agents typified by sodium dialkyl succinate sulfonates and naphthalenesulfonic acid-formalin condensates; and fluorescent brightening agents typified by bis(triazinylamino)stilbene disulfonic acid derivatives, bisstyrylbiphenyl derivatives, coumarin derivatives and pyrazoline derivatives, which may be used alone or in combination.

Other exemplary additives to be blended as required include a swelling agent, a penetrating agent, an emulsifying/dispersing agent, a metal ion sequestering agent, a level dyeing agent, a softening agent, a suspending agent, a migration inhibitor, a carrier, a dye resisting agent, a wrinkle preventing agent and a texturing agent.

Depending on the types of the auxiliary agents and the additives to be used for the treatment liquid and the material for the resin product, a water-soluble organic solvent such as ethanol, n-propanol or ethylene glycol may be used together with water or instead of water. In some cases, a nonaqueous solvent may be used.

<Production Method for Antiviral Finished Product>

Next, an antiviral finished product production method according to the embodiment of the present disclosure will be described. In the production method according to the embodiment of the present disclosure, the resin product for the intended product is brought into contact with the treatment liquid containing the antiviral compound (A) described above and, in this state, a predetermined heat treatment is performed. The method of bringing the resin product into contact with the treatment liquid and the method of performing the heat treatment with the resin product in contact with the treatment liquid are properly selected depending on the type of the resin product to be treated and the material for the resin product.

Exemplary methods include: a first method in which the resin product is immersed in the treatment liquid and, in this state, heat-treated at a predetermined temperature under a predetermined pressure; and a second method in which the treatment liquid is applied to the resin product under a normal pressure by immersion (impregnation), spraying, coating or the like, and the resin product is squeezed at a predetermined squeezing percentage by means of a mangle or by centrifugal separation and then heat-treated under a normal pressure or under an increased pressure.

In the first method, where the resin product is the fiber product, for example, the proportion of the antiviral compound (A) to be contained in the treatment liquid is preferably 0.005 to 20.0% owf (on weight of fiber, or w/w based on the weight of the resin product), more preferably 0.01 to 10.0% owf. The liquid ratio (the weight ratio of the solution to the product to be treated) is preferably 1:5 to 1:30, more preferably, 1:5 to 1:20.

The resin product is immersed in the treatment liquid under normal atmospheric pressure or under increased pressure, and treatment conditions including a temperature, a period and a pressure for the heat treatment in the immersed state are properly set depending on the material for the resin product and the shape of the resin product. Typically, the treatment temperature is set within a range of 70° C. to 230° C., and the treatment period is set within a range of 0.1 minute to 60 minutes. As the temperature and the pressure are increased, the treatment period is reduced. Where a resin product for which the heat treatment at a higher temperature for a longer period is not preferred is heat-treated, the heat treatment conditions are preferably alleviated by applying the pressure. Where resin products are sequentially treated, it is preferred, in terms of the equipment, to perform the treatment under normal atmospheric pressure. Where resin products are treated in a batch, it is preferred to reduce the treatment period by performing the treatment under the increased pressure. The pressure to be applied to the resin products for the heat treatment is not limited, but the pressure may be in a pressure range so as to occur when the heat treatment is performed in a sealed system.

If the proportion of the antiviral compound (A) is excessively small, the resulting antiviral finished product is liable to have a poorer antiviral property. If the proportion of the antiviral compound (A) is excessively great, on the other hand, the resin product is disadvantageously liable to suffer from the abnormalities (hardening, shrinkage, discoloration and the like). If the heat treatment is performed at an insufficient temperature for an insufficient treatment period under higher liquid ratio conditions, the antiviral composition (A) is liable to be insufficiently immobilized on the resin product, resulting in poorer antiviral property. If the treatment temperature and/or the treatment period exceed the aforementioned corresponding ranges, the resin product is disadvantageously liable to suffer from the abnormalities (hardening, shrinkage, discoloration and the like).

In the second method, where the treatment liquid is applied to the resin product under normal atmospheric pressure by the immersion (impregnation), the spraying, the coating or the like, the proportion of the antiviral compound (A) to be contained in the treatment liquid is preferably 0.005 to 20.0% ows (on weight of solution, or w/w based on the concentration of the antiviral compound (A) in the treatment liquid), more preferably 0.01 to 10.0% ows. The squeezing percentage, which may vary depending on the type of the resin product, is preferably 30 to 200%.

After the application of the treatment liquid to the resin product, the heat treatment is performed, for example, at a treatment temperature of 70° C. to 230° C. under normal atmospheric pressure or under increased pressure. More specifically, the resin product is dried at 100° C. to 130° C. for 1 to 3 minutes (where the resin product has a smaller unit weight, the preliminary drying may be obviated), and then a curing treatment is performed at 140° C. to 230° C. The curing period, which may vary depending on the unit weight and the physical properties of the resin product, is preferably about 30 seconds to about 1 hour. If the antiviral compound (A) is present in a smaller proportion in the treatment liquid in this method, the resulting antiviral finished product is liable to have a poorer antiviral property. If the treatment temperature and/or the treatment period are insufficient, the antiviral finished product is liable to be poorer in antiviral property or to be insufficient in water resistance and laundry durability. If the proportion of the antiviral compound (A), the treatment temperature and/or the treatment period are greater than the aforementioned corresponding ranges, on the other hand, the resin product is disadvantageously liable to suffer from the abnormalities (hardening, shrinkage, discoloration and the like).

<Properties of Antiviral Finished Product and Evaluation of Antiviral Finished Product>

As described above, the antiviral finished product produced by the production method according to the embodiment of the present disclosure has excellent antiviral properties against both the envelope type viruses and the non-envelope type viruses, and is effective for various types of viruses. Further, the antiviral finished product maintains excellent antiviral properties for a longer period of time with water resistance and laundry durability and, therefore, can be repeatedly washed with water, wiped with a wet cloth or subjected to laundry to be thereby kept clean during prolonged use.

Specific examples of the viruses for which the antiviral finished product according to the embodiment of the present is effective include poxviruses, orthomyxoviruses (e.g., human influenza viruses and avian influenza viruses), caliciviruses (e.g., noroviruses and feline caliciviruses), paramyxoviruses, arenaviruses, rhabdoviruses, coronaviruses, retroviruses, bunyaviruses, herpesviruses, adenoviruses, reoviruses, togaviruses, papovaviruses, picornaviruses, parvoviruses and filoviruses.

Next, test methods for evaluating the antiviral finished product for the antiviral properties according to the embodiment of the present disclosure will be described.

### <Test Method for Laundry Durability Evaluation>

In the laundry durability evaluation, the antiviral finished product is evaluated for household laundry durability by performing the following household laundry process or evaluated for industrial laundry durability by performing the following industrial laundry process, depending on the type of the antiviral finished product to be evaluated.

### (1) Household Laundry Process (at 40° C.)

The antiviral finished product is laundered at 40° C. 10 times by a laundry method conforming to JIS L0217-103.

### (2) Industrial Laundry Process (at 80° C.)

The antiviral finished product is laundered at 80° C. 10 to 50 times by a bacteriostatic laundry method specified by JTETC (a simplified method conforming to Ordinance No. 13 issued by the Ministry of Health, Labor and Welfare).

The antiviral finished product to be evaluated is subjected to the household laundry process 10 times or to the industrial laundry process 10 or 50 times. Then, 5 g of the resulting antiviral finished product is sampled and immersed in 100 g of deionized water. In this state, the antiviral compound (A) is extracted at 130° C. for 30 minutes in a pressure-proof stainless steel container. The antiviral compound (A) in the resulting extract is quantitatively analyzed. (The quantitative analysis is performed by a UV-visible spectrophotometer in conformity with “Quantitative Analysis of Cationic Surface Active Agent, Photoelectric Colorimetric Method with Phenol Blue Complex” Surface Active Agent Handbook, First Edition, published on Oct. 1, 1968 by Kogaku Tosho. In the quantitative analysis, an eosin complex is used instead of the phenol blue complex.)

### <Test Method for Antiviral Property Evaluation>

In the present disclosure, the antiviral activity is determined for the antiviral property evaluation by the following plaque assay method (proposed by the Antiviral Finishing Committee, Japan Textile Evaluation Technology Council), the following embryonated egg culture method (proposed by the Avian Zoonoses Research Center, Tottori University), or a dog kidney cell culture method or a cat kidney cell culture method (proposed by Japan Food Research Laboratories), depending on the type of the viruses. Where the antiviral activity thus determined is not less than 3, the antiviral finished product is rated as effective. The description of the dog kidney cell culture method and the cat kidney cell culture method is omitted.

(1) Plaque Assay Method

The influenza viruses (of the envelope type, including human influenza viruses) or the feline caliciviruses (of the non-envelope type, used instead of the congeneric noroviruses, which cannot be artificially cultured) are used for the assay. Dog kidney cells are used for the influenza viruses, and cat kidney cells are used for the feline caliciviruses. After a sample to be evaluated is kept in contact with a virus liquid at 25° C. for 2 hours, the kidney cells are post-cultured together with the virus liquid. The number of viruses present in the cultured cells (infectivity) is calculated, and the antiviral activity is calculated based on a difference in logarithmic value between the sample and a blank (untreated material). Where the antiviral activity is not less than 3, the antiviral finished product is rated as effective.

(2) Embryonated Egg Culture Method

After a sample to be evaluated is kept in contact with a virus liquid at a room temperature for 1 hour, an embryonated egg is post-cultured together with the virus liquid. The number of viruses present in the embryonated egg (infectivity) is calculated, and the antiviral activity is calculated based on a difference in logarithmic value between the sample and a blank (untreated material). Where the antiviral activity is not less than 3, the antiviral finished product is rated as effective.

### EXAMPLES

Next, inventive examples will be described in conjunction with comparative examples. It should be understood that the present disclosure be not limited to the inventive examples.

In the inventive examples and the comparative examples, the quantitative analysis of the amount of a remaining compound was based on the aforementioned test methods for laundry durability evaluation. An antiviral finished product to be evaluated was subjected to the predetermined household laundry processor the predetermined industrial laundry process. Then, 5 g of the resulting antiviral finished product was sampled, and immersed in 100 g of deionized water. In this state, the compound was extracted at 130° C. for 30 minutes in a pressure-proof stainless steel container. The antiviral compound (A) or other compound in the resulting extract was quantitatively analyzed.

Although the evaluation criteria vary depending on the type of the viruses, the antiviral finished product was evaluated for the antiviral property against the influenza viruses based on the effective amount of the remaining compound in the following manner:

∘ (Excellent): The amount of the remaining compound was not less than 150 ppm.
Δ (Acceptable): The amount of the remaining compound was less than 150 ppm and not less than 100 ppm.
x (Unacceptable): The amount of the remaining compound was less than 100 ppm.

The abbreviations of compounds used in the inventive examples and the comparative examples are as follows:

DDAC: Didecyldimethylammonium chloride
BAC: Alkyldimethylbenzylammonium chloride
DDAB: Didecyldimethylammonium bromide
PDIEC1: Poly[oxyethylene(dimethylimino)ethylene(dimethylimino)ethylene dichloride] (having a molecular weight of 900)
PDIEC2: Same as above (having a molecular weight of 2000)
DDAA: Didecyldimethylammonium adipate
DDAP: N,N-didecyl-N-poly(oxyethylene)ammonium propionate (having a molecular weight of 2000)
PHMB: Polyhexamethylenebiguanidine chloride (having a molecular weight of 2000)

### Examples 1 to 4

Polyester standard fabrics (available under the trade name of TROPICAL from Teijin Ltd., hereinafter the same) were respectively immersed in 0.32 wt. % and 0.16 wt. % aqueous solutions of DDAC and 0.32 wt. % and 0.16 wt. % aqueous solutions of BAC, then squeezed at a squeezing percentage of 100% by means of a mangle, and dried at 130° C. for 1 minute. Then, a curing treatment was performed on the resulting polyester standard fabrics under the following three different conditions: at 170° C. for 2 minutes; at 180° C. for 1 minute; and at 200° C. for 30 seconds. These process steps were performed under a normal atmospheric pressure, i.e., under neither an increased pressure nor a reduced pressure (in the following examples, the process steps were performed under the normal atmospheric pressure unless otherwise specified). The resulting fabrics were each subjected to the household laundry process at 40° C. 10 times, and then the amount of the remaining compound was quantitatively analyzed. The fabrics thus treated were each evaluated based on the aforementioned criteria. The results are shown below in Table 1.

TABLE 1
<Amount of antiviral compound (A) remaining after 10-
time household laundry process (40° C.)>

| | Resin product: Polyester (fabric) | | | |
|---|---|---|---|---|
| | | Treatment conditions | | |
| | Compound | 170° C. × | 180° C. × | 200° C. × |
| | (wt. %) | 2 min. | 1 min. | 30 sec. |
| Example 1 | DDAC (0.32) | ∘ | ∘ | ∘ |
| Example 2 | DDAC (0.16) | ∘ | ∘ | ∘ |
| Example 3 | BAC (0.32) | ∘ | ∘ | ∘ |
| Example 4 | BAC (0.16) | ∘ | ∘ | ∘ |

From the above results, it was confirmed that, where the polyester standard fabrics were heat-treated under the predetermined conditions after being brought into contact with the antiviral compounds (A), the antiviral compounds (A) remained immobilized on fibers of the polyester standard fabrics.

### Examples 5 to 8

Polyester standard fabrics were respectively immersed in 0.32 wt. % aqueous solutions of DDAC, BAC, DDAB and PDIEC1 (having a molecular weight of 900) and then squeezed at a squeezing percentage of 100% by means of a mangle. Then, a curing treatment was performed on the resulting polyester standard fabrics at 180° C. for 1 minute. The resulting fabrics were each subjected to the household laundry process at 40° C. 10 times or subjected to the industrial laundry process at 80° C. 50 times, and then the amount of the remaining compound was quantitatively analyzed. The fabrics thus treated were each evaluated based on the aforementioned criteria. The results are shown below in Table 2.

### Comparative Examples 1 to 3

Polyester standard fabrics were respectively immersed in a 0.36 wt. % aqueous solution of PDIEC2 (having a molecular weight of 2000), a 0.32 wt. % aqueous solution of DDAP (having a molecular weight of 2000) and a 0.40 wt. % aqueous solution of PHMB (which was not an ammonium salt), and then squeezed at a squeezing percentage of 100% by means of a mangle as in Examples 5 to 8. Then, a curing treatment was performed on the resulting polyester standard fabrics at 180° C. for 1 minute. The resulting fabrics were each subjected to the household laundry process at 40° C. 10 times or subjected to the industrial laundry process at 80° C. 50 times, and then the amount of the remaining compound was quantitatively analyzed. The fabrics thus treated were each evaluated based on the aforementioned criteria. The results are also shown below in Table 2.

TABLE 2
<Amount of antiviral compound (A) remaining
after ten-time household laundry process (40°
C.) or 50-time industrial laundry process (80° C.)>

| | Resin product: Polyester (fabric) | | |
|---|---|---|---|
| | | Treatment conditions | |
| | | 180° C. × 1 min. | |
| | Compound | 10-time household | 50-time Industrial |
| | (wt. %) | laundry | laundry |
| Example 5 | DDAC (0.32) | ∘ | ∘ |
| Example 6 | BAC (0.32) | ∘ | Not done |
| Example 7 | DDAB (0.32) | ∘ | Not done |
| Example 8 | PDIEC1 (0.32) | ∘ | Not done |
| Comparative | PDIEC2 (0.36) | x | x |
| Example 1 | | | |
| Comparative | DDAP (0.32) | x | x |
| Example 2 | | | |
| Comparative | PHMB (0.40) | x | x |
| Example 3 | | | |

From the above results, it was confirmed that, in the case of the polyester standard fabrics of Examples 5 to 8 heat-treated under the predetermined conditions after being brought into contact with the antiviral compounds (A), the antiviral compounds (A) remained immobilized on fibers of the polyester standard fabrics even after the household laundry process was performed 10 times (the industrial laundry process was performed 50 times in Example 5). It was also confirmed that, in the case of the polyester standard fabrics heat-treated under the predetermined conditions after being brought into contact with the compounds different from the antiviral compounds (A), the compounds insufficiently remained on fibers of the polyester standard fabrics.

### Example 9

A polyester/cotton fiber blend fabric (containing 80 wt. % of a polyester and 20 wt. % of cotton) was dyed with 0.5% ows of diaminostilbene sulfonic acid fluorescent brightening agent, and then dried. The resulting fabric was immersed in a 0.32 wt. % aqueous solution of DDAC, then squeezed at a squeezing percentage of 100% by means of a mangle, and dried at 130° C. for 1 minute. Then, a curing treatment was performed on the resulting polyester/cotton fiber blend fabric at 170° C. for 2 minutes. The resulting fabric was subjected to the household laundry process at 40° C. 10 times, and then the amount of the remaining compound was quantitatively analyzed. The fabric thus treated was evaluated based on the aforementioned criteria. The results are shown below in Table 3.

### Comparative Examples 4 and 5

Polyester/cotton fiber blend fabrics (each containing 80 wt. % of a polyester and 20 wt. % of cotton) were dyed with 0.5% ows of diaminostilbene sulfonic acid fluorescent brightening agent, and then dried. The resulting fabrics were respectively immersed in a 0.40 wt. % aqueous solution of DDAA and a 0.40 wt. % aqueous solution of DDAP, then squeezed at a squeezing percentage of 100% by means of a mangle, and dried at 130° C. for 1 minute. Then, a curing treatment was performed on the resulting polyester/cotton fiber blend fabrics at 170° C. for 2 minutes. The resulting fabrics were each subjected to the household laundry process at 40° C. 10 times, and then the amount of the remaining compound was quantitatively analyzed. The fabrics thus treated were evaluated based on the aforementioned criteria. The results are also shown below in Table 3.

TABLE 3
<Amount of antiviral compound (A) remaining after 10-
time household laundry process (40° C.)>

Resin product: Polyester/cotton (fabric)

| | | Treatment conditions |
|---|---|---|
| | Compound | 130° C. × 1 min., |
| | (wt. %) | 170° C. × 2 min. |
| Example 9 | DDAC (0.32) | ∘ |
| Comparative | DDAA (0.40) | x |
| Example 4 | | |
| Comparative | DDAP (0.40) | x |
| Example 5 | | |

From the above results, it was confirmed that, where the polyester/cotton fiber blend fabric (containing 80 wt. % of the polyester and 20 wt. % of the cotton) was heat-treated under the predetermined conditions after being brought into contact with the antiviral compound (A), the antiviral compound (A) remained immobilized on fibers of the polyester/cotton fiber blend fabric even after the household laundry process was performed 10 times. It was also confirmed that, where the polyester/cotton fiber blend fabrics were heat-treated under the predetermined conditions after being brought into contact with the compounds different from the antiviral compound (A), the compounds insufficiently remained on fibers of the polyester/cotton fiber blend fabrics.

### Example 10

A polyamide fiber (nylon 6) sample fabric (available under the trade name of NYLON-6 JERSEY from Shikisensha Co., Ltd.) was immersed in a 0.32 wt. % aqueous solution of DDAC, and then heat-treated at 85° C. for 45 minutes. The resulting fabric was subjected to the household laundry process at 40° C. 10 times, and then the amount of the remaining compound was quantitatively analyzed. The fabric thus treated was evaluated based on the aforementioned criteria. The results are shown below in Table 4.

TABLE 4
<Amount of antiviral compound (A) remaining after 10-
time household laundry process (40° C.)>

Resin product: Polyamide (fabric)

| | Component | Treatment conditions |
|---|---|---|
| | (wt. %) | 85° C. × 45 min. |
| Example 10 | DDAC (0.32) | ∘ |

From the above results, it was confirmed that, where the polyamide fiber fabric was heat-treated under the predetermined conditions after being brought into contact with the antiviral compound (A), the antiviral compound (A) remained immobilized on fibers of the polyamide fiber fabric even after the household laundry process was performed 10 times.

### Examples 11 to 13

Polyester standard fabrics were respectively immersed in 0.40 wt. %, 0.20 wt. % and 0.10 wt. % aqueous solutions of DDAC, and then a curing treatment was performed on the polyester standard fabrics at 180° C. for 1 minute. The resulting fabrics were each subjected to the household laundry process at 40° C. 10 times or subjected to the industrial laundry process at 80° C. 50 times. Thereafter, the fabrics thus treated were each evaluated for an antiviral property against the human influenza viruses and an antiviral property against the feline caliciviruses (as an alternative to the noroviruses) by the aforementioned plaque assay method. The polyester standard fabric immersed in the 0.10 wt. % aqueous solution of DDAC and then subjected to the curing treatment (Example 13) was not evaluated for the antiviral property against the feline caliciviruses. The results are shown below in Table 5.

### Comparative Example 6

Polyester standard fabrics were immersed in a 0.32 wt. % aqueous solution of DDAA, and then squeezed at a squeezing percentage of 100% by means of a mangle. Then, a curing treatment was performed on the resulting polyester standard fabrics at 180° C. for 1 minute. The resulting fabrics were each subjected to the household laundry process at 40° C. 10 times or subjected to the industrial laundry process at 80° C. 50 times. Thereafter, the fabrics thus treated were evaluated for an antiviral property against the human influenza viruses and an antiviral property against the feline caliciviruses in the same manner as in Examples 11 to 13. The results are shown below in Table 5.

TABLE 5
<Antiviral activity after 10-time household laundry process (40°
C.) or 50-time industrial laundry process (80° C.)>

| | Resin product: Polyester (fabric) | | | | |
|---|---|---|---|---|---|
| | Treatment conditions: 180° C. × 1 min. | | | | |
| | | Antiviral activity | | | |
| | | (logarithmic value for untreated case − | | | |
| | | logarithmic value for treated case) | | | |
| | | Human | | Feline | |
| | | influenza viruses | | caliciviruses | |
| | | 10-time | 50-time | 10-time | 50-time |
| | | house- | indus- | house- | indus- |
| | Compound | hold | trial | hold | trial |
| | (wt. %) | laundry | laundry | laundry | laundry |
| Example 11 | DDAC | >3 | Not done | >3 | Not done |
| | (0.40) | | | | |
| Example 12 | DDAC | >3 | >3 | >3 | >3 |
| | (0.20) | | | | |
| Example 13 | DDAC | >3 | Not done | Not done | Not done |
| | (0.10) | | | | |
| Comparative | DDAA | <3 | Not done | <3 | Not done |
| Example 6 | (0.32) | | | | |

From the above results, it was confirmed that the polyester standard fabrics of Examples 11 to 13 heat-treated under the predetermined conditions after being brought into contact the antiviral compound (A) each had a sufficient antiviral activity with the antiviral compound (A) remaining on fibers thereof even after the household laundry process was performed 10 times (the industrial laundry process was performed 50 times in Example 12). It was also confirmed that the polyester standard fabrics heat-treated under the predetermined conditions after being brought into contact with the compound different from the antiviral compound (A) were insufficient in antiviral activity.

### Comparative Example 7

Cotton satin fabrics (each having a unit weight of 125 g/m² and available from Shikisensha Co., Ltd.) were immersed in a 0.20 wt. % aqueous solution of PHMB, then squeezed at a squeezing percentage of 100% by means of a mangle, and dried at 130° C. for 2 minutes. The resulting fabrics were subjected to the household laundry process at 40° C. 10 times. Thereafter, the fabrics thus treated were evaluated for an antiviral property against the feline caliciviruses (as an alternative to the noroviruses) and an antiviral property against the avian influenza viruses by the aforementioned plaque assay method. The results are shown below in Table 6.

### Comparative Example 8

Cotton satin fabrics (each having a unit weight of 125 g/m² and available from Shikisensha Co., Ltd.) were immersed in a 2.00 wt. % aqueous solution of DDAA, then squeezed at a squeezing percentage of 100% by means of a mangle, and dried at 130° C. for 2 minutes. The resulting fabrics were subjected to the household laundry process at 40° C. 10 times. Thereafter, the fabrics thus treated were evaluated for an antiviral property against the human influenza viruses and an antiviral property against the feline caliciviruses in the same manner as in Comparative Example 7. The results are also shown below in Table 6.

TABLE 6
<Antiviral activity after 10-time household laundry (40° C.)>

| | Comparative product: Cotton (fabric) | | | |
|---|---|---|---|---|
| | Treatment conditions: 130° C. × 2 min. | | | |
| | | Antiviral activity | | |
| | | (logarithmic value for untreated case − | | |
| | | logarithmic value for treated case) | | |
| | | Human | | Avian |
| | Component | influenza | Feline | influenza |
| | (wt. %) | viruses | caliciviruses | viruses |
| Comparative | PHMB (0.20) | Not done | <3 | <3 |
| Example 7 | | | | |
| Comparative | DDAA (2.00) | <3 | <3 | Not done |
| Example 8 | | | | |

From the above results, it was confirmed that the cotton satin fabrics heat-treated under the predetermined conditions after being brought into contact with the compounds different from the antiviral compound (A) were insufficient in antiviral activity.

The results shown in Tables 1 to 6 indicate that the products of the inventive examples produced by immersing the fabrics of the synthetic fibers or the fabrics of the fiber blend including the synthetic fibers and the natural fibers in the treatment liquids containing the antiviral compounds (A) and heat-treating the fabrics were satisfactory in antiviral properties with the antiviral compounds (A) immobilized on the fabrics and remaining on the fabrics even after the household laundry process was performed 10 times or the industrial laundry process was performed 50 times.

In contrast, the products of the comparative examples produced by employing the compounds (DDAA, DDAP, PHMB and PDIEC2 (which is a quaternary ammonium halide having a molecular weight of greater than 1500) different from the antiviral compound (A) of the quaternary ammonium halide having a molecular weight of not greater than 1500 were insufficient in antiviral properties because the compounds were not immobilized on the fabrics.

While specific forms of the embodiment of the present disclosure have been shown in the aforementioned inventive examples, the inventive examples are merely illustrative of the disclosure but not limitative of the disclosure. It is contemplated that various modifications apparent to those skilled in the art could be made within the scope of the disclosure. This application is based on Japanese Patent Application No. 2014-147749 filed on Jul. 18, 2014, the disclosure of which is incorporated herein by reference.

The present disclosure is utilized to provide an antiviral finished product which has water-resistant and laundry-durable antiviral properties against a wide variety of viruses.

1-8. (canceled)

9. An antiviral finished product production method for producing an antiviral finished product having an antiviral property, the method comprising the steps of:
preparing a resin product;
preparing a treatment liquid containing an antiviral compound of a quaternary ammonium halide having a molecular weight of not greater than 1500; and
immobilizing the antiviral compound on at least a surface of the resin product by heat-treating the resin product under a normal atmospheric pressure or under an increased pressure with the resin product in contact with the treatment liquid.

10. The antiviral finished product production method according to claim 9, wherein the resin product comprises at least one resin selected from a polyester resin, a polyamide resin, an acryl resin and a polyurethane resin.

11. The antiviral finished product production method according to claim 9, wherein the resin product comprises a polyester resin.

12. The antiviral finished product production method according to claim 9,
wherein, in the step of immobilizing the antiviral compound on at least the surface of the resin product, having the resin product in contact with the treatment liquid is performed by spraying the treatment liquid onto the resin product, by immersing the resin product in the treatment liquid or by coating the resin product with the treatment liquid, and
wherein, in the step of immobilizing the antiviral compound on at least the surface of the resin product, the heat-treating is performed in a gas at 70° C. to 230° C. under the normal atmospheric pressure or under the increased pressure.

13. The antiviral finished product production method according to claim 9,
wherein, in the step of immobilizing the antiviral compound on at least the surface of the resin product, having the resin product in contact with the treatment liquid is performed by immersing the resin product in the treatment liquid, and
wherein, in the step of immobilizing the antiviral compound on at least the surface of the resin product, the heat-treating is performed in the treatment liquid at 70° C. to 230° C. under the normal atmospheric pressure or under the increased pressure.

14. An antiviral finished product produced by the production method according to claim 9, the antiviral finished product comprising:
a resin product; and
an antiviral compound immobilized on at least a surface of the resin product,
wherein the antiviral compound comprises a quaternary ammonium halide having a molecular weight of not greater than 1500, and
wherein the antiviral finished product has an antiviral activity level of not less than 3.

15. The antiviral finished product according to claim 14, wherein the resin product comprises at least one resin selected from a polyester resin, a polyamide resin, an acryl resin and a polyurethane resin.

16. The antiviral finished product according to claim 14, wherein the resin product comprises a polyester resin.

17. The antiviral finished product according to claim 14, wherein the resin product is a fiber product.

18. The antiviral finished product according to claim 14, wherein the resin product is one of a resin sheet, a resin film and a cured resin product having a predetermined shape.
